(19) United States
(12) Patent Application Publication
(10) Pub. No.: US 2019/0344965 A1
(43) Pub. Date: Nov. 14, 2019

(54) SYSTEMS AND METHODS FOR AUTOMATED STORAGE AND RETRIEVAL

(71) Applicant: Walmart Apollo, LLC, Bentonville, AR (US)

(72) Inventors: Bruce W. Wilkinson, Rogers, AR (US); David G. Tovey, Rogers, AR (US); Trent Miller, Bentonville, AR (US); Henk Niemansverdriet, Bentonville, AR (US)

(21) Appl. No.: 16/411,917

(22) Filed: May 14, 2019

Related U.S. Application Data
(60) Provisional application No. 62/671,147, filed on May 14, 2018.

(51) Int. Cl. B65G 1/137; G06Q 30/06; G06Q 50/28

(52) U.S. Cl. CPC B65G 1/1371; B65G 1/1373; G06Q 50/28; G06Q 30/0631

(57) ABSTRACT

Exemplary embodiments describe a system, method and computer-readable medium for providing items for purchase at an automated storage and retrieval system in a facility. Example embodiments include a storage tower configured to store and dispense items, where the storage tower includes storage receptacles, shelves, a receiving opening, a delivery opening, sensors, a user interface, and a transport apparatus for transporting storage receptacles from the shelves to the delivery opening. A computing device, in communication with the sensors and transport apparatus is configured to execute a purchase module to determine items as possible purchase items and transmit instructions to pick the items and place them in a storage receptacle. The storage receptacle is presented to a user via the delivery opening, and the purchase module detects a user removing at least one item from the storage receptacle and identifies the removed item using data sensed by the sensors.

### CROSS-REFERENCE TO RELATED APPLICATIONS

This application claims priority to and benefit of U.S. Provisional Patent Application No. 62/671,147, filed May 14, 2018, the disclosure of which is incorporated herein by reference in its entirety.

### BACKGROUND

Customers can purchase items online and then pick them up in the store. When shopping in the store, customers may browse and purchase items on an impulse.

### BRIEF DESCRIPTION OF DRAWINGS

Some embodiments are illustrated by way of example in the accompanying drawings and should not be construed to limit the present disclosure:

FIG. 1 is a schematic of an exemplary storage tower, in accordance with an exemplary embodiment;

FIG. 2 depicts an interior view of an exemplary storage tower, in accordance with an exemplary embodiment;

FIG. 3 is a schematic of an interior view of an exemplary storage tower, in accordance with an exemplary embodiment;

FIG. 4 is a schematic of an exemplary system for automated picking of items for storage in a storage tower, according to an example embodiment;

FIG. 5 is a block diagram showing an example storage tower system in terms of modules, according to an example embodiment;

FIG. 6 is a flow chart showing an example method for providing items at an automated storage and retrieval system in a facility, according to an example embodiment;

FIG. 7 illustrates a network diagram depicting a system for implementing the storage tower system, according to an example embodiment; and

FIG. 8 is a block diagram of an exemplary computing device that may be used to implement exemplary embodiments of the storage tower system described herein.

### DETAILED DESCRIPTION

Described in detail herein are systems and methods for providing items for purchase at an autonomous storage and retrieval system. Exemplary embodiments include a storage tower programmed to store and dispense items. The storage tower includes storage receptacles to hold items and multiple shelves to support the storage receptacles. The storage tower also includes a receiving opening and one or more delivery openings disposed on an outer surface of the storage tower to enable the storage tower to receive and deliver storage receptacles. Various sensors are disposed with respect to the delivery openings. A transport apparatus is operatively disposed in the storage tower to transport storage receptacles from the shelves to the delivery openings. The storage tower also includes a user interface to allow a user to interact with the storage tower. The storage tower is a self-service terminal for click and collect automated order pickup.

In one embodiment, a computing device is communicatively coupled with a transport apparatus and sensors within a storage tower. The computing device includes a purchase module that when executed determines one or more items as possible purchase items or impulse purchase items of possible interest to a customer based on a customer profile of a customer who placed an order for pick up. The computing device transmits instructions for picking the two or more possible purchase items, placing them in a storage receptacle, and providing the storage receptacle to the storage tower via the receiving opening. In one embodiment, the instructions may be transmitted to a mobile device associated with a user tasked with “picking” items to fulfill orders. In another embodiment, the instructions may be transmitted to an automated apparatus that retrieves the items and places them in a storage receptacle. The storage tower includes a transport apparatus that stores the storage receptacle on a shelf therewithin for later retrieval. The storage tower also stores a storage receptacle with one or more items for the order placed by the customer. When the customer arrives at the storage tower to pick up an order and is identified, the purchase module transmits instructions to the transport apparatus based on the identification to transport the storage receptacle with the possible purchase items to one of the delivery openings of the storage tower, along with the storage receptacle containing the item(s) for the order placed by the customer. In this manner, the items the customer ordered for pick up at the storage tower, along with items that the customer may be interested in purchasing on an impulse, are presented to the customer. The sensors in the tower may detect the customer removing at least one item from the storage receptacle containing the possible or impulse purchase items. This data is forwarded to the purchase module which identifies the removed item (as described further herein) in response to receiving a user input at the storage tower indicating an intent to purchase the removed items. In one embodiment, the removed item may also be identified in the absence of an indication of intent to purchase to identify possible theft of the removed item.

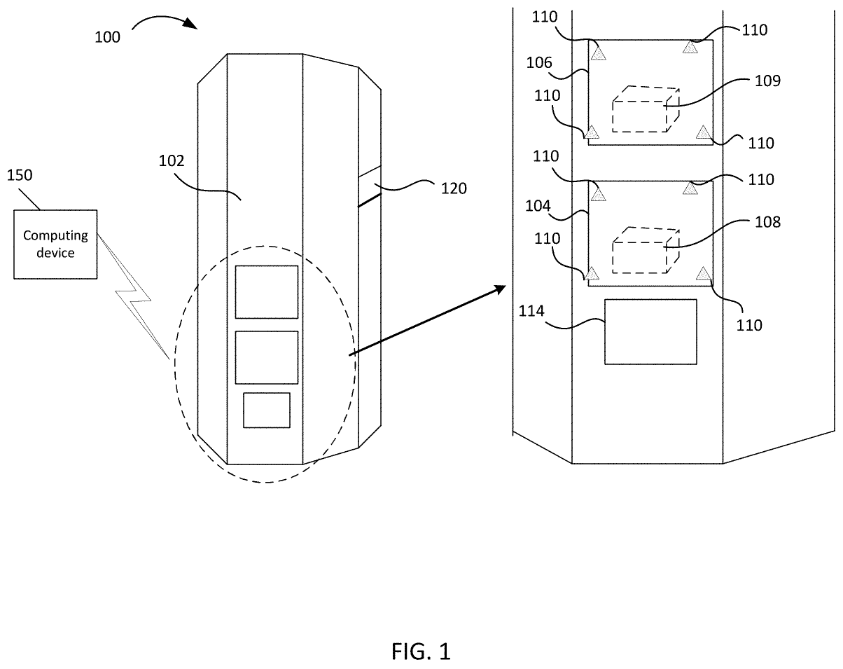

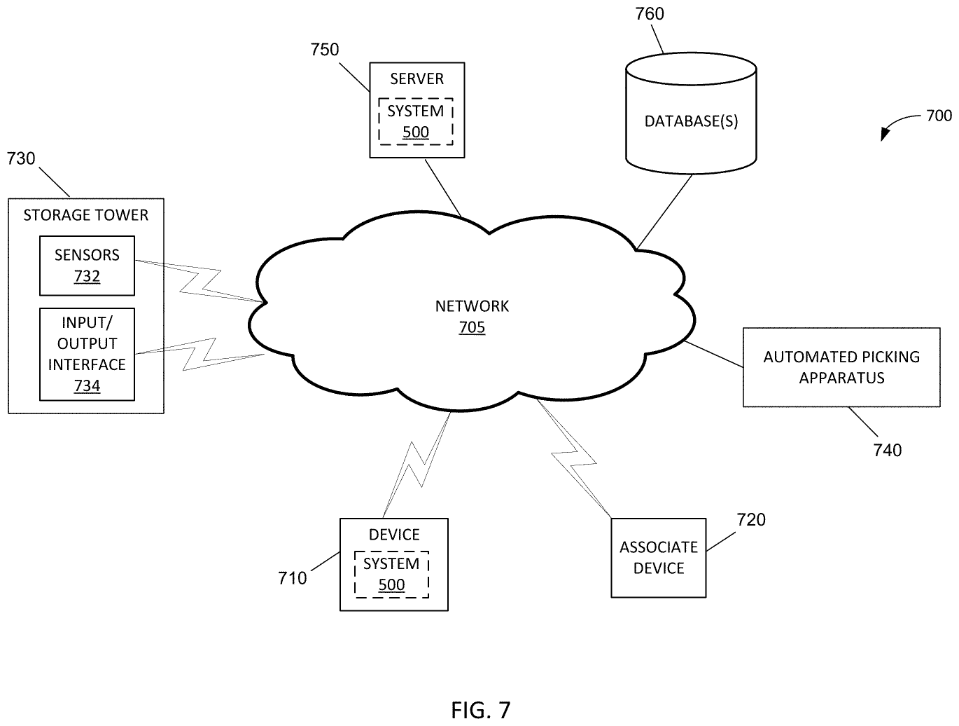

FIG. 1 is a schematic of an exemplary storage tower 100 in accordance with an example embodiment. The storage tower 100 is in communication with a computing device 150 (e.g., computing device 710 of FIG. 7) via a wireless connection, a wired connection, a Bluetooth connection or Near-Field-Communication connection. The storage tower 100 includes one or more delivery openings 104, 106 and a user interface 114 configured to accept user input that is disposed on an outer surface 102 of the storage tower 100. In one embodiment, the user interface may be a graphical user interface. The storage tower 100 also includes a receiving opening 120 to receive storage receptacles for storage in the storage tower 100.

Multiple sensors 110 are disposed about the delivering openings 104, 106 of the exemplary storage tower 100. A first storage receptacle 108 may be presented to the customer via delivery opening 104. A second storage receptacle 109 may be presented to the customer via delivery opening 106. The user interface 114 can include a display to display information to the customer. The user interface 114 may be a touch-screen interface enabled to receive input from the customer when the customer touches the user interface, a keyboard, pin pad, optical scanner, image capturing device, or other input interface via which the customer may provide inputs to the storage tower 100.

In an example embodiment, the storage tower 100 can be of an octagonal shape. The storage tower 100 can have eight outside surfaces including a front surface 102, and the delivery openings 104, 106 can be disposed on the front surface 102. The receiving opening 120 may be disposed one of the side surfaces as shown in FIG. 1.

The user interface 114 can display information associated with a request for dispensing an item(s) for an order pickup through the delivery opening 104, 106 of the storage tower 100. As an example, a customer can input information associated with a request for dispensing item(s) for an order pickup. The information can be an identifier, name, username, pin number, or other information identifying the order. As a non-limiting example, the customer can enter the information, via a touchscreen display incorporated in the user interface 114. Alternatively, or in addition to, the user interface 114 can have multiple input devices such as a keyboard, mouse, joystick, touchpad, or other devices configured to interact with the user interface 114 and the storage tower 100. The customer can input identification information using the user interface 114.

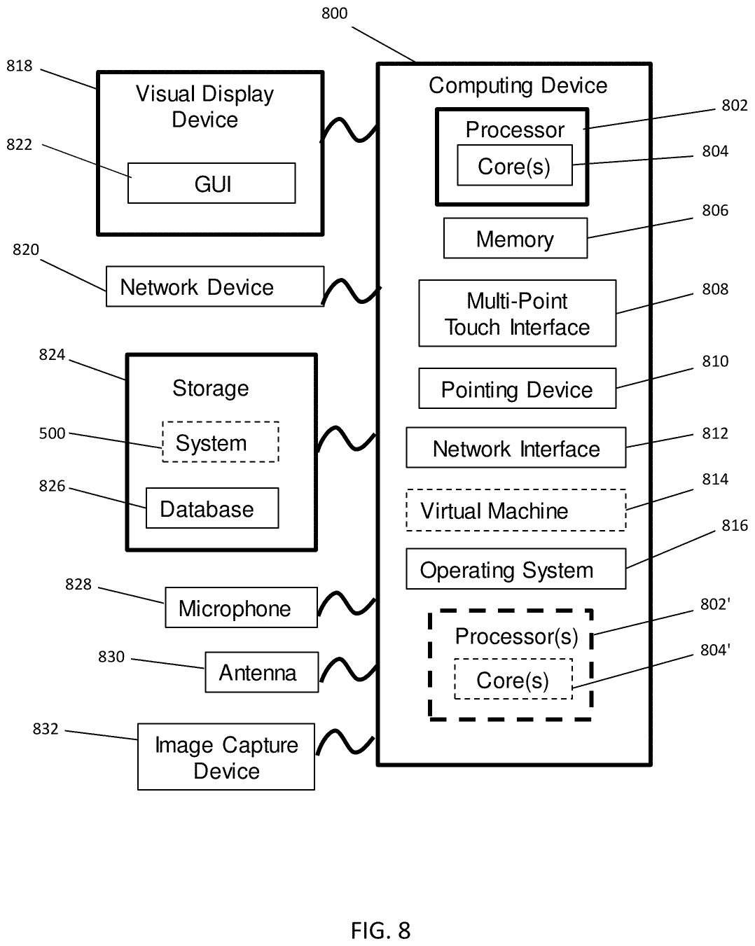

The customer may also scan a machine-readable element encoded with an identifier associated with the order, using the user interface 114. As an example, the user interface 114 can be an optical scanner or an image capturing device. The user interface 114 can scan/capture and decode the identifier from the machine-readable element. In one embodiment, the machine-readable element can be a barcode or a QR code displayed on a customer's smartphone or other mobile device. The user interface 114 can transmit the identifier to the computing device 150. The computing device 150 can include one or more components of computing device 800 described in connection with FIG. 8.

In one embodiment, a motion sensor may be disposed the front surface 102 of the storage tower 100. The motion sensor can detect a customer approaching the storage tower 100, within a given radius. The doors of the delivery openings 104, 106 may automatically open in response to the motion sensor detecting a customer approaching the storage tower 100. Alternatively, or in addition to, the user interface 114 may be powered down (in energy saving mode) and in response to the motion sensor detecting a customer entering the radius, the user interface 114 may power on.

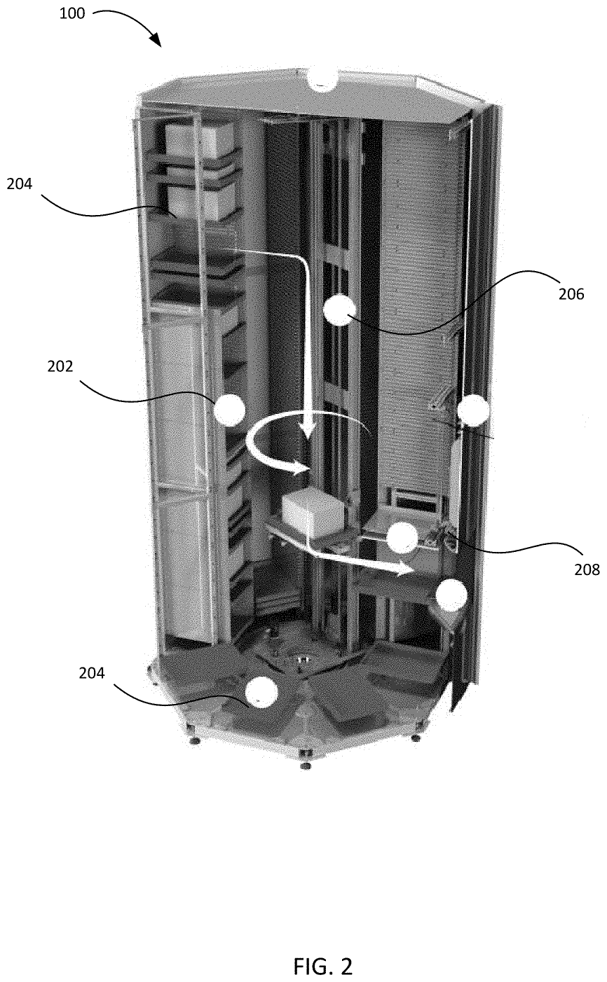

FIG. 2 depicts an interior of an exemplary storage tower 100, in accordance with an example embodiment. The storage tower 100 can be an autonomous storage and retrieval system to store and dispense items or storage receptacles. The interior of the storage tower 100 can include a shelving unit 201, storage receptacles 204 for storing one or more items, a transport apparatus 206, and a delivery opening 208. The shelving unit 201 can include multiple shelves 202 configured to store and support storage receptacles 204. In an example embodiment, the storage receptacle 204 is a container such as a tote or a box. In another embodiment, the storage receptacle 204 is a tray. The shelving unit 201 may be disposed along one of the interior walls of the storage tower 100. It can be appreciated that shelving units 201 may be disposed along each interior wall of the storage tower 100.

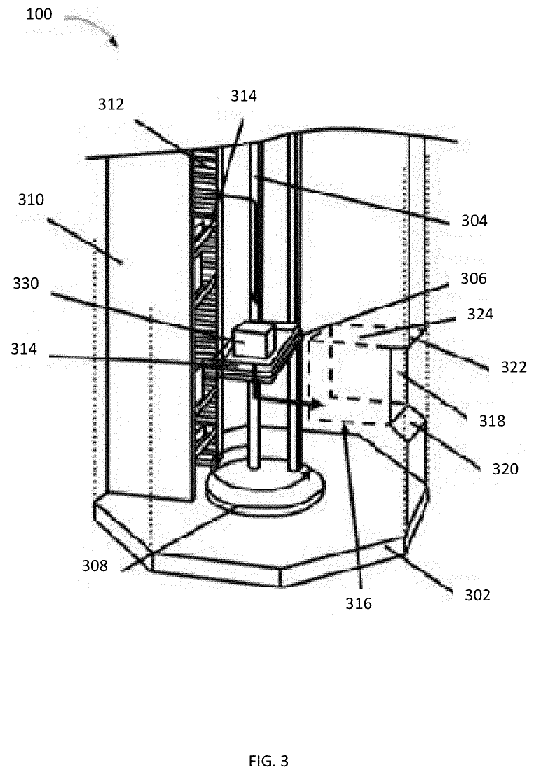

FIG. 3 is a schematic illustrating the interior of an exemplary storage tower 100, in accordance with an example embodiment. The example storage tower 100 includes a base frame 302, a main boom 304 with a loader 306 fastened to a rotating base 308 that is coupled to the base frame 302. The storage tower 100 further includes a circular set-up of multiple shelves 310 arranged in multiple shelving racks. The shelves include rails 312 around the rotating base. The storage tower 100 further includes multiple storage receptacles 314 that are placed on the shelf rails 312 and allow rearrangement on rails. The storage tower 100 also includes a console 316. The transport apparatus 206 (described in connection with FIG. 2) can extend perpendicularly from the boom 304.

In one embodiment, the console 316 includes a delivery opening with a door 318, a user interface 320, a motion sensor 322, and a camera 324. The storage tower 100 may be connected to a computing device (e.g., device 710 or server 750) in order to process data, generate user and parcel codes and for identifying users with a web application or smart device application, as well as sending data to the storage tower 100.

In response to the purchase module receiving an identifier from the tower via the user interface that indicates the customer's presence at the tower, the boom 304 and the loader 306 may bring a storage receptacle 314 from the rails 312 of the shelves 310 with one or more items 330 in it, and take it to the console 316 to present it to the user. For example, in one embodiment, the customer may manually provide input to an input interface provided by the tower. In another embodiment, the customer may be programmatically identified via a query to the customer's smartphone/smartphone app sent by the tower using a variety of technologies, NFC, Bluetooth™, etc. Once the customer is identified, the storage tower 100 may then open the door 318. The main boom 304 moves the loader 306 to left and right according to predetermined degrees, for example up to 315 degrees both ways. That allows fast and efficient retrieval of storage receptacles 314 from the shelves, and placement of storage receptacles 314 onto the shelves.

The transport apparatus 206 can receive instructions to load a storage receptacle 314 from the shelving unit 310, onto the transport apparatus 206 and transport the storage receptacle 314 to the delivery opening at the console 316. The rotating base 308 can be configured to rotate the boom 304 circumferentially, 360 degrees, around the interior of the storage tower 100 so that the boom 304 is parallel to the appropriate shelving unit 310. The transport apparatus 206 can vertically move up and down the boom 304 to align itself with the shelf on which the requested storage receptacle 314 is disposed. The transport apparatus 206 can slide under the storage receptacle 314 and pick it up. The transport apparatus 206 can move along the boom 304, transport and deposit the storage receptacle 314 in the console 316 for delivery to the customer.

In an example embodiment, a customer can request the tower to dispense item(s) relating to an order pickup, stored in the storage tower 100. The customer may input identification information associated with the order using the user interface 114 or may be automatically identified. The identification information is transmitted to the computing device 150. It should be appreciated that in one embodiment computing device 150 may be located at a remote location from the tower. In another embodiment, computing device 150 may be integrated into the tower structure. The computing device 150 transmits instructions to the transport apparatus 206 of the storage tower 100 to dispense the item(s). The instructions initiate movement of the boom 304, loader 306 and other mechanical components of the storage tower 100 to retrieve the storage receptacle containing item(s) associated with the order, and loading the storage receptacle at console 316. The storage tower 100 can dispense the items for the order pickup through the delivery opening 104 or 106 of the storage tower 100. As described herein, the storage tower 100 also transmits instructions to the transport apparatus 206 (based on instructions received from the purchase module) to move the boom 304, loader 306 and other mechanical components of the storage tower 100 to retrieve another storage receptacle containing possible purchase items or impulse purchase items and transporting the storage receptacle through the other delivery opening 104 or 106. This enables the customer to purchase items in addition to the items originally included in the order that the customer is there to pick up.

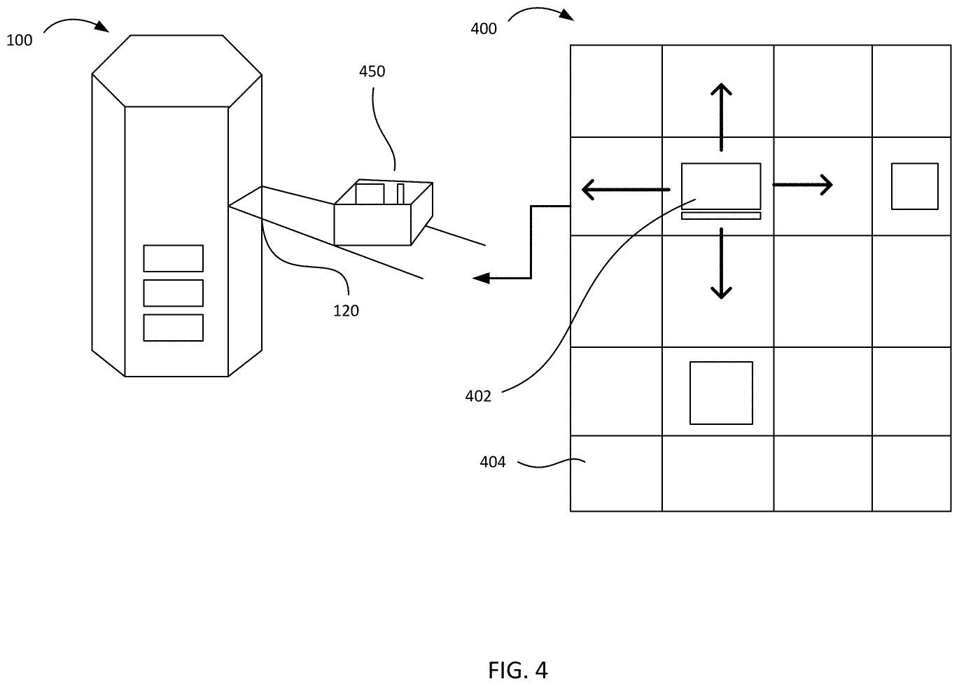

As noted above, the items for the order or the possible purchase or impulse items may be retrieved manually by a human “picker” or by an automated picking apparatus. FIG. 4 is a schematic of an exemplary system for automatic picking of items for storage in the storage tower 100. The system includes an automated picking apparatus 400. The automated picking apparatus 400 includes a crane robot shuttle 402 that is capable of moving up and down, and left and right to pick items associated with an order. The automated picking apparatus 400 can store multiple items that may often be used as possible purchase items or impulse purchase items. The items picked by the crane robot shuttle 402 is stored in the storage receptacle 450 and provided to the storage tower 100 via receiving opening 120. In some embodiments, the automated picking apparatus 400 is configured to sort unpurchased items from the storage receptacle 450 into the compartments 404 of the automated picking apparatus 400, and make them available for picking later.

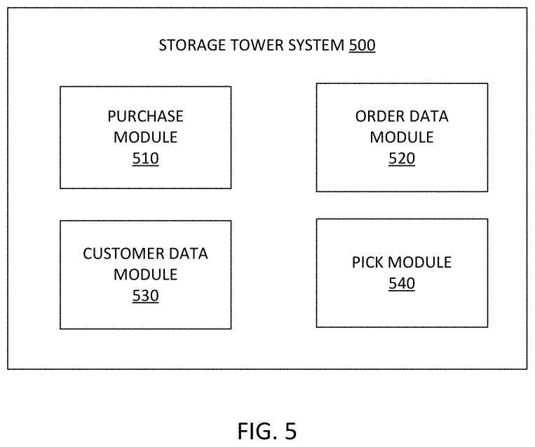

FIG. 5 is a block diagram showing a storage tower system 500 in terms of modules according to an example embodiment. The modules may be implemented in computing device 710 or server 750 shown in FIG. 7. The modules include a purchase module 510, an order data module 520, a customer data module 530, and a pick module 540. The modules may include various circuits, circuitry and one or more software components, programs, applications, apps or other units of code base or instructions configured to be executed by one or more processors included in device 710 or server 750. Although modules 510, 520, 530 and 540 are shown as distinct modules in FIG. 5, it should be understood that modules 510, 520, 530 and 540 may be implemented as fewer or more modules than illustrated. It should be understood that any of modules 510, 520, 530 and 540 may communicate with one or more components included in system 700 (FIG. 7), such as device 710, associate device 720, storage tower 730, automated picking apparatus 740, server 750, and database(s) 760.

The purchase module 510 can be configured to determine items as possible purchase items or impulse purchase items and transmit instructions to a user device associated with a picker or to an automated picking device to pick the items for an impulse purchase storage receptacle. The purchase module 510 can also be configured to instruct the transport apparatus of the storage tower to transport one or more storage receptacles to the delivery openings of the storage tower. The purchase module 510 can be configured to identify one or more items removed from the impulse purchase tote by the customer, and facilitate completion of a purchase transaction at the storage tower by including the removed items in the transaction total.

The order data module 520 can be configured to manage and analyze data related to orders, for example online orders, and facilitate fulfillment of orders submitted by customers.

The customer data module 530 can be configured to manage and analyze data related to customers, including customer name, customer identifier number, data related to current order, data related to past orders, data related to past purchases, customer demographics data, customer preferences, and the like. The customer data module 530 may be configured to create and store a customer profile that helps in identifying items for impulse purchases. The customer profile may include data related to items purchased via a current order, data related items purchased in the past, data related to preferred items, data related to seasonal items, data related to events, and the like.

The pick module 540 can be configured to receive data for picking items, and automatically retrieve the specified items to fulfill an order or an impulse purchase tote. For example, the pick module may be part of a mobile application executing on a mobile device associated with a picker or as part of an automated picking apparatus.

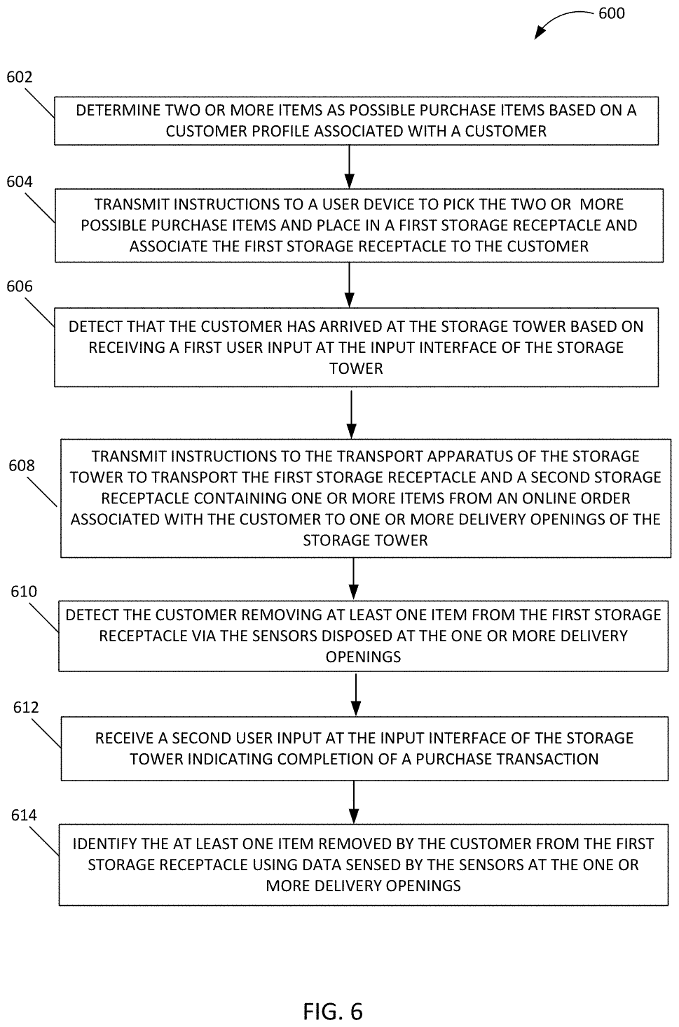

FIG. 6 is a flow chart showing an example method 600 for providing items at an automated storage and retrieval system in a facility, according to an example embodiment. The method 600 may be performed using the modules in the storage tower system 500 shown in FIG. 6.

At step 602, the purchase module 510 determines two or more items as possible purchase or impulse items for a customer based on a customer profile associated with the customer. The possible purchase items or impulse purchase items may be items determined to be related to or complementary to the item(s) in the order that the customer is picking up at the storage tower, or they may be items relevant to the season, or they may be items related to an event. In one embodiment, the possible purchase items or impulse purchase items may include two to fifteen items. In some embodiments, the possible purchase items or impulse purchase items may be fewer than two or more than fifteen.

The possible purchase items or impulse purchase items may be items that are accessories to the item(s) in the order or may be items that are used with the item(s) in the order that the customer is picking up. As another example, the possible purchase items or impulse purchase items may include items that are often displayed near checkout lanes, including but not limited to, beverages, candy, chocolate, gum, magazines, batteries, and the like.

In one embodiment, the possible purchase items or impulse purchase items may be determined based on items frequently bought with the item(s) in the order that the customer is picking up. For example, if the customer is picking up a DVD player or a Blu-ray player, then the possible purchase items or impulse purchase items may include cables compatible for use with the DVD or Blu-ray player and DVD or Blu-ray discs for movies or television shows. Based on the customer's past purchases, the possible purchase items or impulse purchase items may not include DVD or Blu-ray discs that the customer had previously purchased. The possible purchase items or impulse purchase items may also include snacks that are often enjoyed while watching movies, such as popcorn, chips, candy, etc. Based on the customer's past purchases, the possible purchase items or impulse purchase items may include a particular brand of snacks that may be determined as the customer's preferred brand.

In one embodiment, the possible purchase items or impulse purchase items may be determined based on the present season. For example, if the season is winter and the customer is picking up an order that includes clothing items, the possible purchase items may include gloves, scarves, hats, and the like, of a particular size and/or gender based on the customer's past purchase history and profile data.

In one embodiment, the possible purchase items or impulse purchase items may be determined based on an event. For example, the Super Bowl or other sporting event may be occurring in the near future or the day that the customer is picking up the order at the storage tower. In this case, the possible purchase items or impulse purchase items may include items relevant to enjoying sporting events, such as snacks, beverages, plates, napkins, sporting memorabilia, and the like. As another example, Thanksgiving may be occurring in the near future or the day that the customer is picking up the order at the storage tower. In this case, the possible purchase items or impulse purchase items may include items relevant to Thanksgiving, such as Thanksgiving themed plates or napkins, serving bowls or utensils, and the like.

At step 604, the purchase module 510 transmits instructions to pick the two or more possible purchase items, place them in a first storage receptacle and associate the first storage receptacle to the customer.

In an example embodiment, the instructions to pick the possible purchase items are transmitted to a processing device of an automated picking apparatus, for example, automated picking apparatus 400 of FIG. 4. The automated picking apparatus picks the two or more possible purchase items, places them in a storage receptacle, and associates the storage receptacle with the customer prior to providing the storage receptacle to the storage tower via the receiving opening (e.g., receiving opening 120). In another embodiment, the instructions are transmitted to a user device associated with a human picker for manual retrieval.

As described here, a machine readable identifier (e.g., barcode, QR code, RFID tag, NFC tag, etc.) is affixed to each storage receptacle. The first storage receptacle containing the two or more possible purchase items is associated with the customer by scanning the machine readable identifier of the first storage receptacle and associating the identifier data with the customer identifier in a database.

The first storage receptacle is provided to the storage tower (e.g., storage tower 100) via the receiving opening 120. The storage tower 100 stores the first storage receptacle on a shelf (e.g., shelf 202) for later retrieval.

At step 606, the purchase module 510 detects that the customer has arrived at the storage tower. For example, the purchase module may receive notification of a first user input entered by the customer at the user interface 114 of the storage tower 100. The customer may enter an order identifier number, a customer name, a customer identifier number, or other identification data via the user interface 114 of the storage tower 100. In another embodiment, the customer may be automatically identified via the customer's mobile device communicating with the tower.

At step 608, the purchase module 510 transmits instructions to the transport apparatus 206 to transport the first storage receptacle to one of the delivery openings 104 or 106 of the storage tower 100. The purchase module 510 transmits instructions to the transport apparatus 206 to also transport a second storage receptacle, which contains one or more items that the customer ordered via an online order, to one of the delivery openings 104 or 106 of the storage tower 100. In some embodiments, the first storage receptacle and the second storage receptacle may be presented to the customer via the same delivery opening. At step 610, the purchase module 510 detects the customer removing at least one item from the first storage receptacle via the sensors ### disposed at the delivery openings. As described herein, the sensors 110 can include a motion detection sensor, a laser sensor, a weight sensor, an image sensor, a pressure sensor, and the like. In an example embodiment, the purchase module 510 detects the customer removing an item based on data sensed by the motion detection sensor and/or the weight sensor.

At step 612, the purchase module 510 receives a second user input at the user interface 114 of the storage tower 100 indicating completion of a purchase transaction. The customer may click or select a button on the user interface 114 (for example, via a keyboard, pin pad or touch-screen interface) indicating that he wants to complete the purchase transaction for the item or items he removed from the first storage receptacle.

At step 614, the purchase module 510 identifies the item or items removed by the customer from the first storage receptacle using the data sensed by the sensors 110 at the delivery openings 104 and 106. For example, the purchase module 510 may identify the item using data sensed by a weight sensor, where the total weight of the items in the first storage receptacle is known and the weight of the items left in the first storage receptacle (after the customer has removed items for purchase) is sensed by the weight sensor. Using the difference between the total weight of the items and the weight of the items left, and the weight of individual items in the first storage receptacle, the purchase module 510 may identify the item or items removed from the first storage receptacle.

In another example, the purchase module 510 may identify the item(s) removed from the first storage receptacle using data sensed by an image sensor and by performing image analysis on the sensed data to identify the item(s). The image analysis may include executing machine vision algorithms. In another embodiment, the image analysis may include executing algorithms to recognize a color, size, shape and/or dimensions of the item to identify the item. The image analysis may include processing the image to identify a barcode, QR code or other identifier to identify the item. In another embodiment, the opening may be equipped with sensors.

In an example embodiment, the purchase module 510 displays the price of the item(s) removed by the customer from the first storage receptacle at the user interface 114 of the storage tower 100 based on identifying the item(s).

In an example embodiment, the purchase module 510 identifies the items remaining in the first storage receptacle as unpurchased items in response to receiving the input indicating completion of the purchase transaction.

In an example embodiment, the storage receptacle with the unpurchased items is provided to the automated picking apparatus 400 and a computing device (e.g., device 710, associate device 720, or server 750) transmits instructions to the automated picking apparatus 400 to automatically sort the unpurchased items for return to inventory storage.

In another embodiment, the unpurchased items are kept in the first storage receptacle for storage within the storage tower 100 for use for another customer later. For example, another customer may have a similar customer profile to the present customer, and the possible purchase items or impulse purchase items may be of interest to the other customer. In this case, the unpurchased items stored in the storage tower 100 can be presented to another customer, rather than sending the unpurchased items back to inventory.

In an example embodiment, the instructions to pick the two or more possible purchase items is transmitted to the user device (e.g., device 720) or the automated picking apparatus 400 when the server 750 determines that the customer is arriving at the facility. The server 750 may determine that the customer is arriving at the facility based on location data transmitted from the customer's mobile device to the server 750. Alternatively, the customer may have indicated a pickup time when placing the order, which may be used to determine when the customer is arriving at the facility.

In an example embodiment, the systems and method described herein enable reuse of the unpurchased items from the impulse purchase storage receptacle as possible purchase items or impulse purchase items for another customer or another storage receptacle. In one embodiment, additional possible purchase items determined for another customer (e.g., customer B) is added to the storage receptacle containing unpurchased items by the first customer (e.g., customer A). This case is exemplified in Table 1 below, where possible purchase items determined for customer A are denoted A₁, A₂, A₃, and so on, and the possible purchase items determined for customer B are denoted B₁, B₂, B₃, and so on.

TABLE 1
Adding Possible Purchase Items to Storage Receptacle without unstocking

| | | | | | | | | Customer | | | | | | | |
|---|---|---|---|---|---|---|---|---|---|---|---|---|---|---|---|
| | | | | | | | | B's | | | | | | | |
| | | | | | | Items | | possible | | | | | | Items | |
| Customer | | | Customer | | | remaining | | purchase | | | Customer | | | remaining | |
| A's picked | | | A selects | | | after | | items are | | | B selects | | | after | |
| possible | | | items A₂, | | | Customer | | stocked in | | | items | | | Customer | |
| purchase | | | A₅, A₆ | | | A | | the same | | | A₁, A₄, B₃, | | | B | |
| items | | → | and A₁₀ | | → | purchases | → | receptacle | | → | B₆, and B₁₀ | | → | purchases | |
| A₁ | A₉ | | A₁ | A₉ | | A₁ | | A₁ | B₃ | | [symbol] | [symbol] | | A₃ | B₇ |
| A₂ | A₁₀ | | [symbol] | [symbol] | | A₃ | | A₃ | B₄ | | A₃ | B₄ | | A₇ | B₈ |
| A₃ | | | A₃ | | | A₄ | | A₄ | B₅ | | [symbol] | B₅ | | A₈ | B₉ |
| A₄ | | | A₄ | | | A₇ | | A₇ | B₆ | | A₇ | [symbol] | | A₉ | |
| A₅ | | | [symbol] | — | | A₈ | | A₈ | B₇ | | A₈ | B₇ | | B₁ | |
| A₆ | | | [symbol] | — | | A₉ | | A₉ | B₈ | | A₉ | B₈ | | B₂ | |
| A₇ | | | A₇ | | | | | B₁ | B₉ | | B₁ | B₉ | | B₄ | |
| A₈ | | | A₈ | | | | | B₂ | B₁₀ | | B₂ | [symbol] | | B₅ | |

In another embodiment, possible purchase items or impulse purchase items are determined for a particular customer type based on often occurring factors in customer profiles, or based on seasons or events. The storage receptacle is restocked after each transaction with the possible purchase items, and therefore may contain more than one of an item. This case is exemplified in Table 2 below, where a storage receptacle is filled with possible purchase items or impulse purchase items for a customer type A.

TABLE 2
Grouping Possible Purchase Items into Customer Types; Restock After Each Transaction

| | | | | | | | | | | | Customer | | | | |
|---|---|---|---|---|---|---|---|---|---|---|---|---|---|---|---|
| | | | | | | Items | | | | | A-2 | | | Items | |
| | | | | | | remaining | | Tote | | | selects | | | remaining | |
| | | | Customer | | | in the | | restocked | | | items one | | | in the | |
| | | | A-l | | | receptacle | | with the | | | of each | | | receptacle | |
| Customer | | | selects | | | after | | same items | | | A₁, A₄, | | | after | |
| Type A's | | | items A₂, | | | Customer | | for the next | | | A₆, A₈, | | | Customer | |
| Stocked | | | A₅, A₆ and | | | A-1 | | type A | | | A₁₀, and | | | A-2 | |
| Tote | | → | A₁₀ | | → | purchases | → | customer | | → | both of A₇ | | → | purchases | |
| A₁ | A₉ | | A₁ | A₉ | | A₁ | | A₁ | A₆ | | [symbol] | [symbol] | | A₁ | A₉ |
| A₂ | A₁₀ | | [symbol] | [symbol] | | A₃ | | A₁ | A₇ | | A₁ | [symbol] | | A₂ | |
| A₃ | | | A₃ | | | A₄ | | A₂ | A₇ | | A₂ | [symbol] | | A₃ | |
| A₄ | | | A₄ | | | A₇ | | A₃ | A₈ | | A₃ | [symbol] | | A₃ | |
| A₅ | | | [symbol] | | | A₈ | | A₃ | A₈ | | A₃ | A₈ | | A₄ | |
| A₅ | | | [symbol] | | | A₉ | | A₄ | A₉ | | [symbol] | A₉ | | A₅ | |
| A₇ | | | A₇ | | | | | A₄ | A₉ | | A₄ | A₉ | | A₈ | |
| A₈ | | | A₈ | | | | | A₅ | A₁₀ | | A₅ | [symbol] | | A₉ | |

In another embodiment, the storage receptacle is filled with several of the same possible purchase items or impulse purchase items so that multiple transactions for a similar customer profile can be performed without needing to restock the storage receptacle. This case is exemplified in Table 3 below.

TABLE 3
Stocking Receptacle with Several Items for a Single
Customer Profile Type for Several Transactions

| | | | | | | | | | Customer A-2 | | | | |
|---|---|---|---|---|---|---|---|---|---|---|---|---|---|
| | | | | | | | | | selects one | | | | |
| | | | Customer | | | | | | each of | | | Items | |
| Possible | | | A-l selects | | | Items | | | items A₁, A₄, | | | remaining | |
| purchase | | | items A₂, | | | remaining | | | both | | | after | |
| items for | | | two of A₅, | | | after | | | remaining of | | | Customer | |
| Customer | | | A₆ and all | | | Customer A- 1 | | | A₆, and two of | | | A-2 | |
| Type A | | → | three of A₁₀ | | → | purchases | | → | A₈ | | → | purchases | |
| A₁ | A₆ | | A₁ | [symbol] | | A₁ | A₇ | | [symbol] | A₇ | | A₁ | A₉ |
| A₁ | A₆ | | A₁ | A₆ | | A₁ | A₇ | | A₁ | A₇ | | A₁ | A₉ |
| A₁ | A₆ | | A₁ | A₆ | | A₁ | A₈ | | A₁ | [symbol] | | A₂ | |
| A₂ | A₇ | | [symbol] | A₇ | | A₂ | A₈ | | A₂ | A₈ | | A₂ | |
| A₂ | A₇ | | A₂ | A₇ | | A₂ | A₈ | | A₂ | A₈ | | A₃ | |
| A₂ | A₇ | | A₂ | A₇ | | A₃ | A₉ | | A₃ | A₉ | | A₃ | |
| A₃ | A₈ | | A₃ | A₈ | | A₃ | A₉ | | A₃ | A₉ | | A₃ | |
| A₃ | A₈ | | A₃ | A₈ | | A₃ | A₉ | | A₃ | A₉ | | A₄ | |
| A₃ | A₈ | | A₃ | A₈ | | A₄ | | | [symbol] | | | A₄ | |
| A₄ | A₉ | | A₄ | A₉ | | A₄ | | | A₄ | | | A₅ | |
| A₄ | A₉ | | A₄ | A₉ | | A₄ | | | A₄ | | | A₇ | |
| A₄ | A₉ | | A₄ | A₉ | | A₅ | | | A₅ | | | A₇ | |
| A₅ | A₁₀ | | [symbol] | [symbol] | | A₆ | | | [symbol] | | | A₇ | |
| A₅ | A₁₀ | | [symbol] | [symbol] | | A₆ | | | [symbol] | | | A₈ | |
| A₅ | A₁₀ | | A₅ | [symbol] | | A₇ | | | A₇ | | | A₉ | |

FIG. 7 illustrates a network diagram depicting a system 700 for implementing the storage tower system, according to an example embodiment. The system 700 can include a network 705, multiple devices, for example device 710 and associate device 720, storage tower 730, automated picking apparatus 740, server 750, and database(s) 760. Each of the devices 710, 720, storage tower 730, automated picking apparatus 740, server 750, and database(s) 760 is in communication with the network 705.

In an example embodiment, one or more portions of the communications network 705 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The device 710 may include, but is not limited to, an embedded computing system, a computing system with a processing device, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The device 710 may include one or more components of the storage tower system 500, and may be in communication with the sensors 732 and input/output interface 734 of the storage tower 730. The device 710 may connect to network 705 via a wired or wireless connection. The device 710 may include one or more components of computing device 800 described in connection with FIG. 8.

The associate device 720 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. A store associate may use the associate device 720. As described herein, the associate device 720 may receive instructions to pick items determined by the storage tower system 500 as possible purchase items. The associate device 720 may include one or more components of computing device 800 described in connection with FIG. 8.

The storage tower 730 may be the storage tower 100 described herein and include various components described in connection with FIGS. 1, 2, and 3.

In an example embodiment, portions of the storage tower system 500 are included on the server 750 and other portions are included on the device 710. Each of the database(s) 760, and the server 750 is connected to the network 705 via a wired connection. Alternatively, one or more of the database(s) 760, and server 750 may be connected to the network 705 via a wireless connection. Although not shown, server 750 can be (directly) connected to the database(s) 760. The server 750 includes one or more computers or processors configured to communicate with devices 710, 720, storage tower 730 and automated picking apparatus 740 via network 705. The server 750 hosts one or more applications or websites accessed by device 710 and associate device 720, and/or facilitates access to the content of database(s) 760. Database(s) 760 comprise one or more storage devices for storing data and/or instructions (or code) for use by the server 750, devices 710, 720, storage tower 730 and automated picking apparatus 740. Database(s) 760, and/or server 750 may be located at one or more geographically distributed locations from each other or from devices 710, 720. Alternatively, database(s) 760 may be included within servers 750.

In exemplary embodiments, one or more storage towers 100 can be disposed in a facility, such as retail store. Items can be stored in the storage tower 100 for automatic retrieval later. A customer can request item(s) to be dispensed as part of an order pickup at the storage tower 100. The customer can input identification information associated with the order at the user interface 114. The computing device 150 receives the identification information and executes at least the purchase module 510 of the storage tower system 500 (described in connection with FIGS. 5 and 6).

In another embodiment, the storage tower may be a storage locker including multiple lockers of various sizes to store item(s) and a user interface. The storage locker can be in communication with a computing device. When a customer inputs an identification number for an order pickup, the computing device can transmit instructions to the storage locker to open a locker door associated with the order. The computing device can also transmit instructions to the storage locker to open another locker door (near the first locker door) to present a storage receptacle containing possible purchase items or impulse purchase items. Sensors can be disposed about each locker door of the storage locker, and may sense data in a similar manner as described in connection with sensors 110 herein to identify items removed from the storage receptacle by the customer for a purchase transaction.

FIG. 8 is a block diagram of an exemplary computing device 800 that may be used to implement exemplary embodiments of the transaction system 100 described herein. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 806 included in the computing device 800 may store computer-readable and computer-executable instructions or software for implementing exemplary embodiments of the transaction system 100. The computing device 800 also includes configurable and/or programmable processor 802 and associated core 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for controlling system hardware. Processor 802 and processor(s) 802′ may each be a single core processor or multiple core (804 and 804′) processor.

Virtualization may be employed in the computing device 800 so that infrastructure and resources in the computing device may be shared dynamically. A virtual machine 814 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof.

A user may interact with the computing device 800 through a visual display device 818, such as a computer monitor, which may display one or more graphical user interfaces 822 that may be provided in accordance with exemplary embodiments. The computing device 800 may include other I/O devices for receiving input from a user, for example, a keyboard or any suitable multi-point touch interface 808, a pointing device 810 (e.g., a mouse), a microphone 828, and/or an image capturing device 832 (e.g., a camera or scanner). The multi-point touch interface 808 (e.g., keyboard, pin pad, scanner, touch-screen, etc.) and the pointing device 810 (e.g., mouse, stylus pen, etc.) may be coupled to the visual display device 818. The computing device 800 may include other suitable conventional I/O peripherals.

The computing device 800 may also include one or more storage devices 824, such as a hard-drive, CD-ROM, or other computer-readable media, for storing data and computer-readable instructions and/or software that implement exemplary embodiments of the transaction system 100 described herein. Exemplary storage device 824 may also store one or more databases for storing any suitable information required to implement exemplary embodiments. For example, exemplary storage device 824 can store one or more databases 826 for storing information, such product information, images captured by cameras, risk ratings for customers, customer information, transaction information, sensor data, and/or any other information to be used by embodiments of the system 100. The databases may be updated manually or automatically at any suitable time to add, delete, and/or update one or more items in the databases.

The computing device 800 can include a network interface 812 configured to interface via one or more network devices 820 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 800 can include one or more antennas 830 to facilitate wireless communication (e.g., via the network interface) between the computing device 800 and a network. The network interface 812 may include a built-in network adapter, network interface card, PCMCIA network card, card bus network adapter, wireless network adapter, USB network adapter, modem or any other device suitable for interfacing the computing device 800 to any type of network capable of communication and performing the operations described herein. Moreover, the computing device 800 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 800 may run an operating system 816, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, or another operating system capable of running on the computing device and performing the operations described herein. In exemplary embodiments, the operating system 816 may be run in native mode or emulated mode. In an exemplary embodiment, the operating system 816 may be run on one or more cloud machine instances.

The following description is presented to enable a person skilled in the art to create and use a computer system configuration and related method and article of manufacture for a storage tower system to facilitate transactions at an automatic retrieval and storage system. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for providing items for purchase at an automated storage and retrieval system in a facility, the system comprising:
a storage tower configured to store and dispense a plurality of items, the storage tower including:
one or more storage receptacles to hold one or more items therewithin;
a plurality of shelves, each configured to support at least one storage receptacle;
a receiving opening disposed on the outer surface of the storage tower to enable the storage tower to receive the one or more storage receptacles;
one or more delivery openings disposed on an outer surface of the storage tower to enable delivery of the one or more storage receptacles to a user that is in physical proximity of the storage tower;
a plurality of sensors disposed with respect to the one or more delivery openings;
a user interface configured to accept user input, the user interface disposed on the outer surface of the storage tower; and
a transport apparatus disposed within the storage tower, the transport apparatus configured to transport storage receptacles from the plurality of shelves to the one or more delivery openings; and
a computing device having a processor communicatively coupled with the plurality of sensors in the storage tower and the transport apparatus in the storage tower, and configured to execute a purchase module that when executed:
determines two or more items as possible purchase items based on a customer profile associated with a customer;
transmits instructions for the two or more possible purchase items to be picked and placed in a first storage receptacle, the first storage receptacle associated with the customer, wherein the first storage receptacle containing the two or more possible purchase items is provided to the storage tower via the receiving opening and is placed on a shelf of the plurality of shelves;
detects that the customer has arrived at the storage tower based on receiving a first user input at the user interface of the storage tower;
transmits instructions to the transport apparatus to transport the first storage receptacle from the shelf to one of the one or more delivery openings and to transport a second storage receptacle containing one or more items from an online order associated with the customer, the instructions transmitted in response to detecting that the customer has arrived at the storage tower;
detects a user removing at least one item from the first storage receptacle via the plurality of sensors disposed at the one or more delivery openings;
receives a second user input at the user interface of the storage tower indicating completion of a purchase transaction; and
identifies the at least one item removed by the customer from the first storage receptacle using data sensed by the plurality of sensors at the one or more delivery openings.

2. The system of claim 1, wherein the purchase module when executed displays a price of the at least one item removed by the customer at the user interface of the storage tower based on identifying the at least one item.

3. The system of claim 1 wherein the purchase module when executed identifies items remaining in the first storage receptacle as unpurchased items by the customer in response to receiving the indication of completion.

4. The system of claim 1, wherein the plurality of sensors includes at least one of a weight sensor, an image sensor, a pressure sensor, a motion detection sensor, and a laser sensor.

5. The system of claim 1, wherein the customer profile includes data relating to past purchases by the customer, data relating to one or more items purchased via an online order for pickup at the storage tower, data relating to seasonal items, and data relating to an event.

6. The system of claim 1, wherein the instructions for picking the two or more possible purchase items are transmitted to a mobile device associated with a user.

7. The system of claim 1, further comprising:
an automated apparatus configured to pick and place items in the one or more storage receptacles prior to the one or more storage receptacles being received by the storage tower, the automated apparatus in communication with the computing device and purchase module; and
wherein the purchase module is configured to transmit instructions to the automated apparatus to pick the two or more possible purchase items and place them in the first storage receptacle.

8. The system of claim 7, wherein the computing device is further configured to:
transmit instructions to the automated apparatus to automatically sort unpurchased items for return to the inventory storage.

9. The system of claim 1, wherein unpurchased items are stored in the first storage receptacle in the storage tower for presentation to another customer.

10. The system of claim 1, wherein the instructions to pick the two or more possible purchase items and place them in a first storage receptacle are transmitted in response to detecting that the customer is arriving at the facility.

11. A method for providing items for purchase at an automated storage and retrieval system in a facility, the method comprising:
providing a storage tower configured to store and dispense a plurality of items, the storage tower including:
one or more storage receptacles to hold one or more items therewithin;
a plurality of shelves, each configured to support at least one storage receptacle;
a receiving opening disposed on the outer surface of the storage tower to enable the storage tower to receive the one or more storage receptacles;
one or more delivery openings disposed on an outer surface of the storage tower to enable delivery of the one or more storage receptacles to a user that is in physical proximity of the storage tower;
a plurality of sensors disposed with respect to the one or more delivery openings;
a user interface configured to accept user input, the user interface disposed on the outer surface of the storage tower; and
a transport apparatus disposed within the storage tower, the transport apparatus configured to transport storage receptacles from of the plurality of shelves to the one or more delivery openings;
determining, at a purchase module executed by a computing device having a processor and communicatively coupled with the plurality of sensors in the storage tower and the transport apparatus in the storage tower, two or more items as possible purchase items based on a customer profile associated with a customer;
transmitting instructions from the purchase module for the two or more possible purchase items to be picked and placed in a first storage receptacle, the first storage receptacle associated with the customer,
wherein the first storage receptacle containing the two or more possible items is provided to the storage tower via the receiving opening and is placed on a shelf of the plurality of shelves;
detecting at the purchase module that the customer has arrived at the storage tower based on receiving a first user input at the user interface of the storage tower;
transmitting instructions from the purchase module to the transport apparatus to transport the first storage receptacle from the shelf to one of the one or more delivery openings and to transport a second storage receptacle containing one or more items from an online order associated with the customer, the instructions transmitted in response to detecting that the customer has arrived at the storage tower;
detecting a user removing at least one item from the first storage receptacle via the plurality of sensors disposed at the one or more delivery openings;
receiving a second user input at the user interface of the storage tower indicating completion of a purchase transaction; and
identifying the at least one item removed by the customer from the first storage receptacle using data sensed by the plurality of sensors at the one or more delivery openings.

12. The method of claim 11, further comprising:
displaying a price of the at least one item removed by the customer at the user interface of the storage tower based on identifying the at least one item.

13. The method of claim 11, further comprising identifying items remaining in the first storage receptacle as unpurchased items by the customer in response to receiving the indication of completion of the purchase transaction.

14. The method of claim 11, wherein the plurality of sensors includes at least one of a weight sensor, an image sensor, a pressure sensor, a motion detection sensor, and a laser sensor.

15. The method of claim 11, wherein the customer profile includes data relating to past purchases by the customer, data relating to one or more items purchased via an online order for pickup at the storage tower, data relating to seasonal items, and data relating to an event.

16. The method of claim 11, further comprising transmitting instructions from the purchase module to a mobile device associated with a user for the two or more possible purchase items to be picked.

17. The method of claim 11, further comprising:
providing an automated apparatus configured to pick and place items in the one or more storage receptacles prior to the one or more storage receptacles being received by the storage tower; and
transmitting instructions from the computing device to the automated apparatus to pick the two or more possible purchase items and place them in the first storage receptacle.

18. The method of claim 17, further comprising:
transmitting instructions from the computing device to the automated apparatus to automatically sort the unpurchased items for return to the inventory storage.

19. The method of claim 11, wherein the unpurchased items are stored in the first storage receptacle in the storage tower for presentation to another customer.

20. The method of claim 11, further comprising:
transmitting instructions to pick the two or more possible purchase items and place them in a first storage receptacle in response to detecting that the customer is arriving at the facility.

21. A non-transitory machine-readable medium storing instructions executable by a processing device, wherein the processing device is in communication with a plurality of sensors in a storage tower and a transport apparatus in the storage tower, and wherein execution of the instructions causes the processing device to implement a method for providing items for purchase at an automated storage and retrieval system in a facility, the method comprising:
determining two or more items as possible purchase items based on a customer profile associated with a customer;
transmitting instructions for the two or more possible purchase items to be picked and placed in a first storage receptacle, the first storage receptacle associated with the customer, wherein the first storage receptacle containing the two or more possible items is provided to the storage tower via a receiving opening and is placed on a shelf of a plurality of shelves within the storage tower;
detecting that the customer has arrived at the storage tower based on receiving a first user input at a user interface of the storage tower;
transmitting instructions to the transport apparatus to transport the first storage receptacle from the shelf to a delivery opening in an outer surface of the storage tower and to transport a second storage receptacle containing one or more items from an online order associated with the customer, the instructions transmitted in response to detecting that the customer has arrived at the storage tower;
detecting a user removing at least one item from the first storage receptacle via the plurality of sensors disposed at the one or more delivery openings;
receiving a second user input at the user interface of the storage tower indicating completion of a purchase transaction; and
identifying the at least one item removed by the customer from the first storage receptacle using data sensed by the plurality of sensors at the one or more delivery openings.

22. The medium of claim 21, wherein the method further comprises:
providing an automated apparatus configured to pick and place items in the one or more storage receptacles prior to the one or more storage receptacles being received by the storage tower; and
transmitting instructions from the computing device to the automated apparatus to pick the two or more possible purchase items and place them in the first storage receptacle.
